(19) United States
(12) Patent Application Publication
(10) Pub. No.: US 2005/0278356 A1
(43) Pub. Date: Dec. 15, 2005

(54) Module editor

(76) Inventor: Frank Welz, Mauer (DE)

Correspondence Address: KENYON & KENYON, 1500 K STREET NW, SUITE 700, WASHINGTON, DC, 20005, US

(21) Appl. No.: 10/862,943

(22) Filed: Jun. 8, 2004

(51) Int. Cl. G06F 7/00

(52) U.S. Cl. 707/100

(57) ABSTRACT

A method is provided for building a module interactively that includes defining an environment by selecting, from a field catalog, input data structures for the module. The method also includes selecting at least one processing step to be performed by the module and relating the at least one processing step to the input data structures. The method may further include selecting, from the field catalog, output data structures for the module. A system is provided for building a module that includes an arrangement adapted to select an environment for the module, an arrangement adapted to define input data structures for the environment by selecting from a field catalog, an arrangement adapted to select process steps to be performed by the module, and an arrangement adapted to associate the input data structures with the process steps to form the module. A method is provided of editing a module. A module building tool adapted to allow a user to perform a method is provided.

### FIELD OF THE INVENTION

The present invention relates to computer software. More particularly, the present invention relates to an editor for modifying business applications used by financial institutions.

### BACKGROUND INFORMATION

Modules may contain a sequence of processing steps. The fields of an input structure may be filled by an application, which may call a module. Once the module is called, the system may apply each processing step of the module in a defined sequence. In this process, the fields of an output structure may be filled. Modules may be hard-coded and therefore not easily customized to a client's unique needs.

Modules may need to operate with a complex and flexible data model. Modules may need to support data enrichment features, perform complex calculations, and model business processes in a flexible way.

There thus is a need for a method of editing a module that is flexible and intuitive.

### BRIEF DESCRIPTION OF THE DRAWINGS

FIG. 1 shows an exemplary architecture of an analyzer using an exemplary embodiment of a module editor.

FIG. 2 shows schematically an exemplary embodiment of a calculation module mapping inputs to outputs.

FIG. 3 shows an exemplary system that accesses a module editor.

FIG. 4 illustrates a screenshot of an exemplary embodiment of the present invention showing a module including a step sequence.

FIG. 5 illustrates a screenshot of an exemplary embodiment of the present invention showing module versions and validity periods.

### DETAILED DESCRIPTION

According to an exemplary embodiment of the present invention, a method for editing a module is provided. The module editor may provide a module that transforms an input structure to an output structure according to key figures and transforms. Adaptation of a module to a customer's particular needs may be possible by customizing the module in the module editor.

The module editor is a tool for creating modules, such as a costing tool or a calculation module. Modules may contain a sequence of processing steps, which may be applied to the fields of an input structure. The results from these fields are then transferred to an output structure. The sequence of processing steps are defined through the editor. Data from the input structure can be used as operands of the processing steps. Data generated by one step may be used as an operand of a subsequent step and data generated by the steps may be used to complete an output structure.

A primary data source is an interface that imports a worklist or a single record. A primary data source may be a standardized means of accessing elementary data sources. The primary data source may define which data is imported by an application from a financial database (also referred to herein as an FDB), analyzers, or other sources that process data.

A secondary data source may be an application of the module editor that receives data in an input structure or from primary data sources, performs calculations, and makes the results available to other applications by means of an output structure.

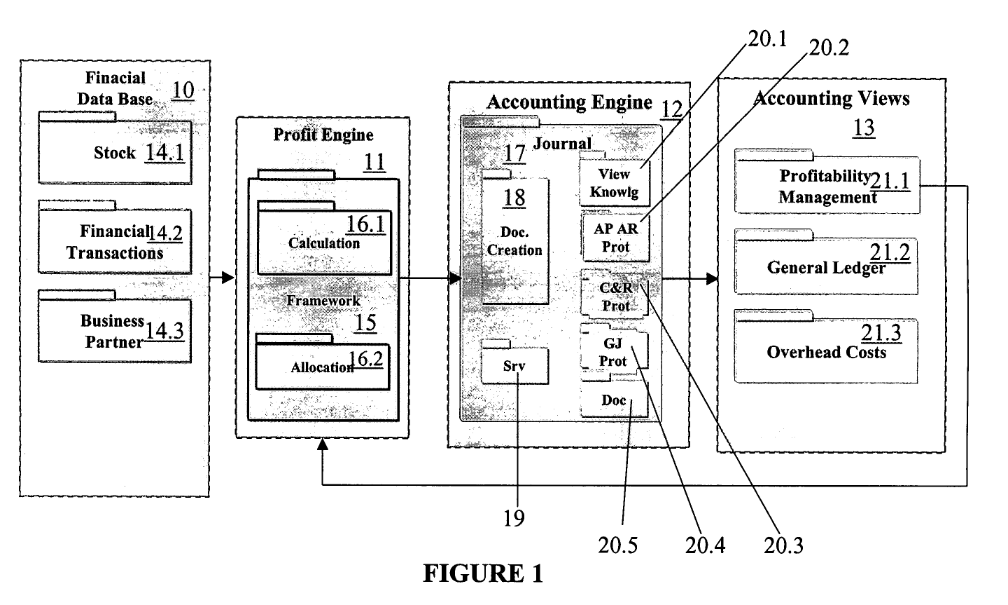

FIG. 1 shows an exemplary architecture of an analyzer using an exemplary embodiment of a module editor. Financial database 10 includes stock 14.1, financial transactions 14.2 and business partner 14.3. Additionally, other financial instruments may be included in financial database 10, for instance loans and/or options. Financial database 10 may input data to profit engine 11. Profit engine 11 includes calculation 16.1 and allocation 16.2 in framework 15. Calculation 16.1 may be modified using a module editor to determine the input data to be processed, the process steps to be performed, and the output data to be provided. Profit engine 11 outputs to accounting engine 12, which includes journal 17. Journal 17 includes document creation 18, server 19, view knowledge 20.1, AP AR prot 20.2, C&R prot 20.3, GJ prot 20.4, and doc 20.5. Accounting engine 12 outputs to accounting views 13, which includes profitability management 21.1, general ledger 21.2, and overhead costs 21.3. Accounting views 13 outputs to profit engine 11.

A field catalog defines a universe of characteristics and key figures available for use in the module editor. The environment selects characteristics and key figures for use in a module. The environment essentially narrows the field catalog to a collection of elements that are to be used to build a given module. Multiple modules may be a member of a single environment.

Environments may have multiple versions, but only one version of an environment may be active at one time. In contrast, modules may have multiple active versions, but for a particular date, only one module may be active.

New environment versions may be created when an environment is created or changed. Possibly only one environment version may be active at one time. Other environment versions may be deactivated upon the creation or activation of a new version. Draft environments may be created and modified but not active. Activating a new environment may then cause a previously active environment to be deactivated.

New module versions may be created whenever a module is created or changed. Multiple versions of a module may be active but only one module may be active for any particular date, which may be referred to as the valid-from date.

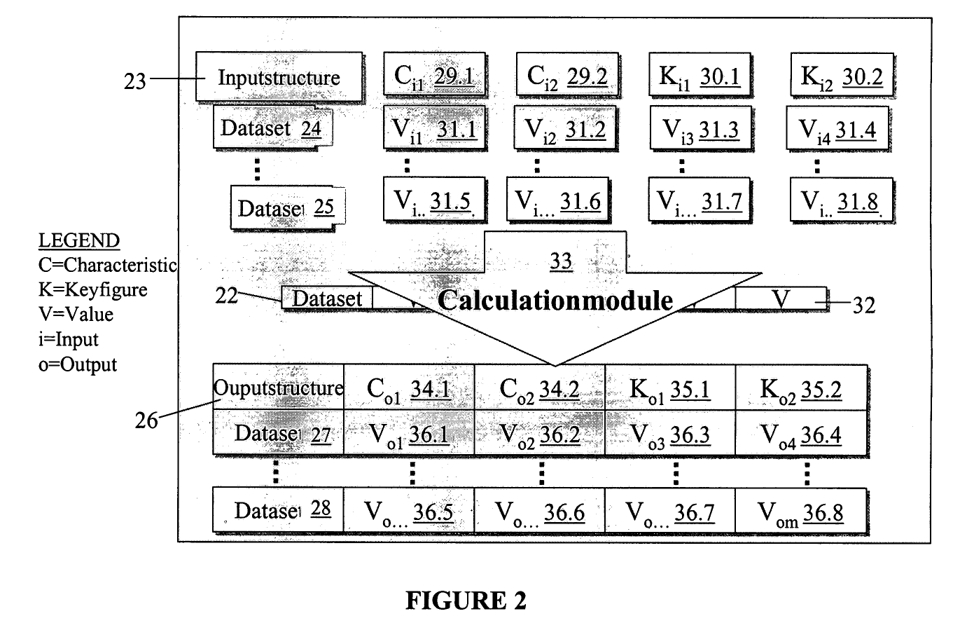

FIG. 2 shows schematically an exemplary embodiment of calculationmodule 33 mapping inputs to outputs. In particular, inputstructure 23 includes characteristics 29.1 and 29.2 and keyfigures 30.1 and 30.2. Additionally, more or fewer characteristics and/or keyfigures may be included in inputstructure 23. Dataset 24 includes values 31.1, 31.2, 31.3, and 31.4. Dataset 25 includes values 31.5, 31.6, 31.7, and 31.8. Additionally, more or fewer values may be included in dataset 24 and/or dataset 25, and more or fewer datasets may be possible.

All of inputstructure 23, dataset 24, and dataset 25 are input into calculationmodule 33. Calculationmodule 33 may produce intermediate dataset 22 including value 32 before outputting outputstructure 26, dataset 27, and/or dataset 28. The outputs of calculationmodule 33 may be the result of processing steps being applied to the inputs and/or intermediate dataset 22 of calculationmodule 33. Calculationmodule 33 may be created and/or edited in a module editor to customize the inputs, outputs, and or processing steps.

Outputstructure 23 includes characteristics 34.1 and 34.2 and keyfigures 35.1 and 35.2. Additionally, more or fewer characteristics and/or keyfigures may be included in outputstructure 26. Dataset 27 includes values 36.1, 36.2, 36.3, and 36.4. Dataset 28 includes values 36.5, 36.6, 36.7, and 36.8. Additionally, more or fewer values may be included in dataset 27 and/or dataset 28, and more or fewer datasets may be possible.

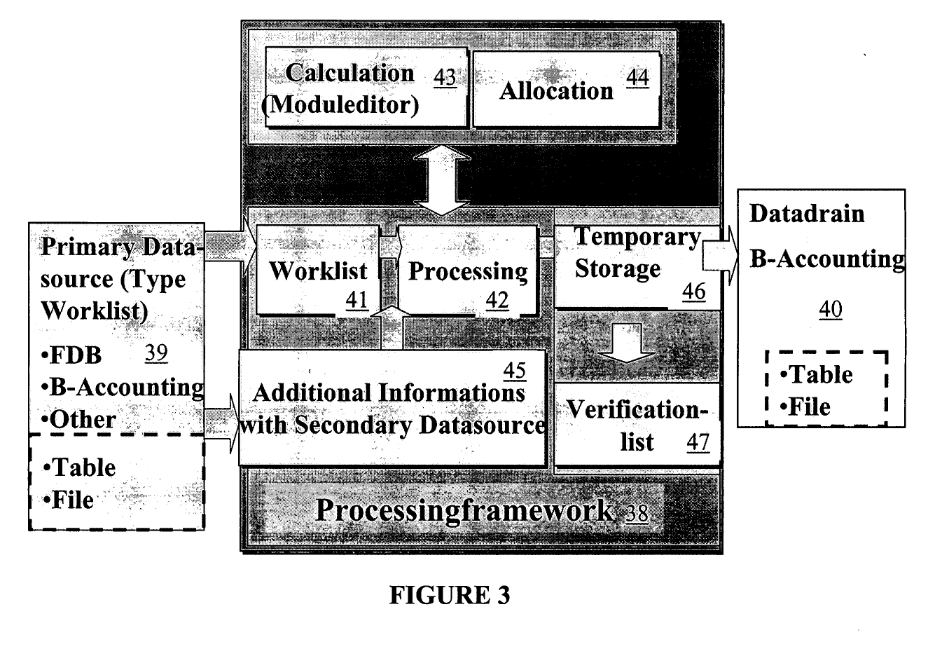

FIG. 3 shows an exemplary system that accesses a module editor. Primary datasource 39 may include several different data sources and/or structures, including a financial database (FDB), an accounting application, tables, files, and/or other sources of data. Primary datasource 39 provides data to processing framework 38. Processing framework 38 includes worklist 41 (which receives the data from primary datasource 39), processing 42, temporary storage 46, verification list 47, and secondary datasource 45 (which receives data from primary datasource 39). Processing framework 38 also communicates information to and from calculation 43 and allocation 44. Both secondary datasource 45 and calculation 43 use a module editor to allow the customization of output data structures based on the editor's selection of input data structures and processing steps.

Processing framework 38 communicates data to datadrain 40, which may include a table, a file, and/or any other appropriate repository or output for data.

A selection menu presents data structures and/or steps that can be added in the module editing process. When a step is selected, a dialog box identifies all fields required by the system to perform the step. A user may then tie input fields (formal input parameters of the processing step) to any of: an input component—a field from an input data structure; a local component—an output of a predecessor step; a system component; a parameter; and an output component.

A local component may be defined for a module version by giving a name and specifying the type. A local component may be assigned to input or output parameters of processing steps. When assigned to an input parameter, a local component may be assigned to an output parameter of a predecessor step.

A system component may only be read during runtime and therefore may only be assigned to input fields of processing steps, not to output fields. The system components may not be defined by the user, but by the specific application which uses the module editor tool. Therefore, the application may provide data as input to each module, which may be the same for all modules and may be specific for the area of the application. Generally, some time information may be provided (e.g. processing date and/or timestamp), which may be assigned to input fields of processing steps which may need this time information.

The parameters are all fields required to perform a step. Parameters may be referred to as formal parameters. If an input, output, local component, or system component is assigned, they may be referred to as actual parameters.

Output components may be filled by a predecessor step and may be assigned to input fields. Output fields (output formal parameters of processing steps) may be tied (or assigned) to output components and local components.

A key figure may open objects and take field names from an attributes screen.

Depending on the connected field catalog, input or output components may be key figures.

The module editor may distinguish between primary data sources and secondary data sources. A primary data source may be located within the system itself, for example an FDB.

The system may open an object and select items that match a particular search criterion (e.g., a customer ID). A secondary data source may be located outside the system, for example, with a business partner. A module may call for additional information from a secondary data source for data enrichment purposes and/or to verify data being used from a primary data source.

Exemplary processing steps that a user may incorporate in a module edited in a module editor include: primary data source; derivation; formal; function module; copy; condition; message; calculation module; value determination; do-loop; internal table; table loop; database table; and comment.

A module editor may be used as a tool for creating modules, which may provide the system with secondary data sources. Modules may contain a sequence of processing steps. The fields of the input structure may be filled by the application, which calls a module. Once the module is called, the system may apply each processing step of the module in the sequence defined in a customizing interface. In this process, the fields of the output structure may be filled. Modules created with the module editor may be used in a bank analyzer to provide secondary data sources, for example. The modules may be used for the following functions: selection of data for a processing step; input to a primary data source; complex calculations for the processing steps formula; derivation; and/or function.

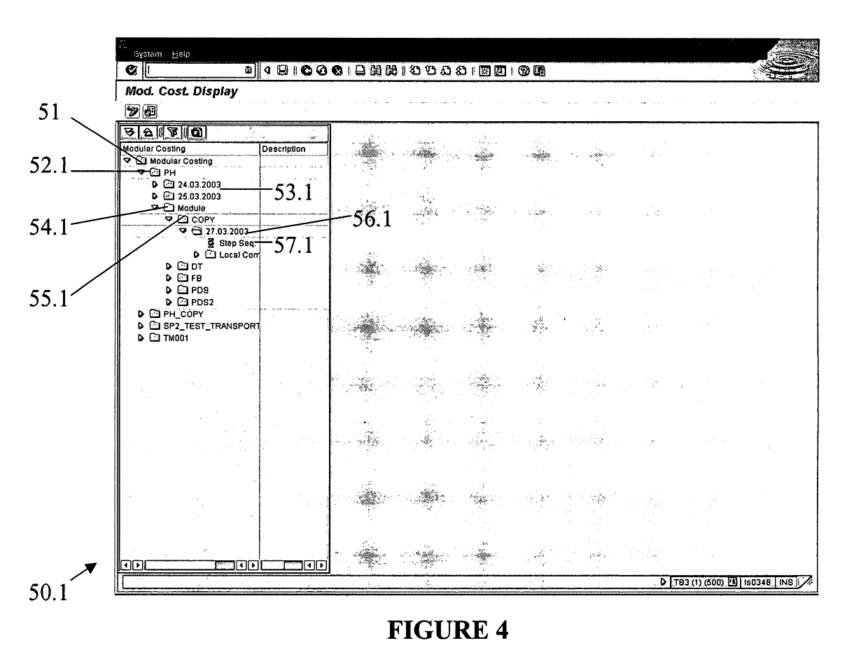

FIG. 4 illustrates an overview of a module editor for creating a calculation module. Display 50.1 shows a tree hierarchy of a module cost display on the left side of the screen display area. Module cost 51 defines a field catalog of inputs for the module costing (referred to in FIG. 4 as modular costing). Environment 52.1 includes environment version 53.1. Environment version 53.1 defines the characteristics and key figures for inputs and/or outputs. Environment version 53.1 may have an associated date, for instance, Mar. 24, 2003 or Mar. 25, 2003, and these dates may serve to identify the respective definitions (e.g., 24.03.2003 and 25.03.2003, respectively). Module editor node 54.1 labeled “Module” enables the creation of individual modules. Under module editor node 54.1 in the tree hierarchy is a list of individual modules 55.1. Within an individual module, module version 56.1 is defined. Module version 56.1 may have an associated date, for instance, Mar. 27, 2003, and these dates may serve to identify the definitions (e.g., 27.03.2003). Within module version 56.1, step sequence 57.1 is defined.

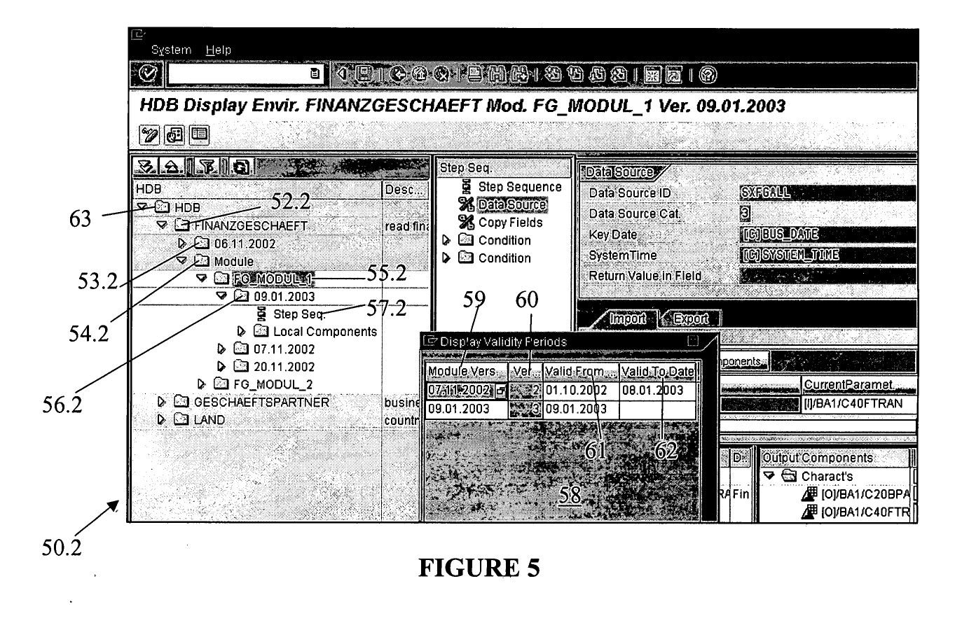

FIG. 5 illustrates another overview of the module editor for creating an historical database (referred to in FIG. 5 as HDB). Display 50.2 shows a tree hierarchy of an HDB display. HDB 63 defines a field catalog of inputs for the module historical database. Environment 52.2 includes environment version 53.2. Environment version 53.2 defines the characteristics and key figures for inputs and/or outputs. Definition 53.2 may have an associated date, for instance, Nov. 6, 2002, and this date may serve to identify the definition (e.g., 06.11.2002). Module editor node 54.2 labeled “Module” enables the creation of individual modules. Under module editor node 54.2 in the tree hierarchy is a list of individual modules 55.2, here named FG_MODUL_1 and FG_MODUL_2. Within an individual module, module version 56.2 is defined. Module version 56.2 may have an associated date, for instance, Jan. 9, 2003, and this date may serve to identify the definitions (e.g., 09.01.2003). Within module version 56.2, step sequence 57.2 is defined. Validity display 58 shows validity periods for particular module versions. Module version date 59 is a column in validity display indicating module version 56.2 showing the associated date which is used to identify the module version in the tree on the left. Version number 60 is a column showing a version number (here, 2 and 3). Initial validity date 61 indicates the first valid date for a particular module version. In this case, version 2 was first valid on 01.10.2002 (i.e., Oct. 1, 2002), while version 3 was first valid on 09.01.2003 (i.e., Jan. 9, 2003). End validity date 62 indicates the last valid date for a particular module version. In this case, version 2 was last valid on 08.01.2003 (i.e., Jan. 8, 2003), while version 3 is still valid.

A module environment version may contain a subset of the fields from the field catalog. The main steps in the flow process are: create an environment; create an environment version; select fields from the field catalog as input and output fields for the environment version; activate the environment version; create a module; create a module version; add local components if necessary; add steps to the step sequence; activate a module version. The operation of adding steps to the step sequence may include assigning fields from the input and/or output structure as actual parameters to formal parameters of the processing step. Additional entries might be necessary depending on the specific step type selected.

In operation, a module that has been called may process all defined processing steps in the defined sequence. By processing the steps, the fields of the output structure are filled.

The terms profit engine, calculation module, allocation, and processing framework belong to a profit analyzer, which is part of a bank analyzer. Calculation modules are modules of the module editor. Allocation is another business function. The processing framework drives the processes in profit analyzer, and may call calculation modules.

The environment (more precisely the input and output structures) may represent the interface for all modules belonging to the same environment. While the field catalog may contain several hundred fields, an environment may contain only a small subset of those fields. Therefore, selecting only the needed fields should improve performance. From a user perspective, the assignment of fields to processing steps may be clearer, as only the fields selected for the environment are available.

Different environments may co-exist, and environments may be specific to different financial operations. For example, a profit analyzer may have Environment 1 for interest rate results and Environment 2 for unit costs.

An architecture for the module editor may include field catalogs, environments and modules, each of which may be editable. The field catalog allows grouping of all the fields that may need to be used in a module. Any of the fields from the characteristics and key figure service of the financial database may be used. There also may be applications that do not use field catalogs.

In an environment, multiple versions and modules may be grouped together. Multiple environments may be created. When an environment is created, the system may automatically create a version of the environment. The version may contain input and output fields, which may be used by the modules belonging to the environment. The fields required from the field catalog may be chosen in order to assign characteristics and key figures as input fields and output fields to an environment version.

For applications that work without a field catalog, an environment category may have to be assigned for a version of an environment. In this situation, the environment category may define which fields may be used to define the processing steps.

More than one version of an environment may be created. However, only one version may be active at any one time. All other versions may be either deactivated or in a new state (i.e., they may be customized in a customizing function). Versions that are deactivated are currently not used, and may no longer be changed in a customizing function. Previous, deactivated versions may document previous customizing states. New versions may be processed and activated. When a new version is activated, the previous version may be automatically deactivated. Active versions may not be changed.

More than one module for an environment may be created. A module may also have multiple versions, and multiple versions of a module may be active. However, each version of a module is assigned a valid-from date, so that for any one point in time only one module version is active.

The module version may consist of a sequence of processing steps. Data from the fields of the environment may be used as parameters for the processing steps. Data structures may be created, which may be provided in the form of parameters by the processing steps, in the local components. This may only need to be done if the fields of the environment do not already contain the data structures. The results of the processing steps may likewise be stored in the fields of the output or changing structure.

Any of various processing steps may be added to the step sequence of a module. A processing step may be added to a step sequence via a selection menu. The system may then display a dialog box that contains all the fields that the system requires for editing the processing step. Which fields are displayed in the dialog box may depend upon the processing step that is selected. The data may be entered that is required for the processing step.

There are some processing steps that require parameters, including function modules and derivations. When the processing step is selected, the system may display the parameters required. The default parameters may then be displayed that are required from the list of input and output components, which may be done by assigning environment components. The system may be able to display these parameters because the formal parameters and actual parameters are of the same type.

The input components, output components, system components, and local components may be assigned directly to a processing step by being copied from the dialog structure to the fields of the respective processing step. Complex key figures may be copied with a structure by choosing the relevant field names from a screen of attributes.

The system may check the assignment of parameters. This function may be used by activating the automatic step/sequence step in a personal settings function. Processing steps may be copied and shifted by using a copy and paste function. A processing step may be deleted in a selection menu by setting a deletion flag. The system may delete the flagged processing step the next time the module version is saved.

The system may contain the various processing steps, including a primary data source step. The program may access a primary data source and select data in a single record procedure. Data may be read from an FDB, from an analyzer (by means of an object transfer structure), or from a general primary data source that may be defined in a customizing function.

The system may display tab pages, which may allow the definition of import and export characteristics. An import tab may allow a user to define which single records the system selects. Under a formal parameters tab, the system may display which characteristics a user can choose. This may depend on which primary data source has been selected. The selection criteria may be defined by assigning actual parameters to each formal parameter. The system may select the data record in which the field contents of the formal parameters match those of the actual parameters.

The characteristics from the input components, system components, and local components may be used as actual parameters. A fixed value may be entered as an actual parameter. If a characteristic from the output component is chosen, then this component has to have been populated with data in an earlier processing step.

By means of export characteristics, a user may define which characteristics and key figures are to be returned by the primary data source. Under formal parameters, the system displays the characteristics and key figures from the primary data source that may be used here. A user may assign an actual parameter to each formal parameter. A user may use characteristics or key figures from the output or local component as actual parameters.

Various information may also be entered, including key date field, system time field, and a return code field. The key date field may refer to the business date of the primary data source that is called (a date field or a fixed value may alternatively or additionally be entered). The system time field may be relevant only if a technical time stamp is used (a time stamp is a combination of a date and a time). The return code field may be an error code that the system generates while processing the data. By means of the return code, the continuing processing may be controlled. An error code of 0 may mean that no errors occurred, while an error code of 1 may mean that there was an error. The fields of the local components may be used for the return code.

A user may also enter the following information: application indicator; date field; return code to field; suppress errors; and a formal step. The date field refers to the business date of the derivation that was called. Return code to field is similar to the return code field described above with respect to the primary data source. If the suppress errors is set, then the system does not write any errors to the log. The formal step indicates that the system makes a calculation. The characteristics and key figures are used from the input-output structure of the active version environment. In this situation, basic arithmetic operations, brackets, and the offset function may be used.

The system may call a function module. A user may choose any of the function modules that have been created, or those predefined in the system for the respective application. By means of the import characteristics, the data may be defined which is to be processed in the function module. The system may display the function module fields that may be used for entering data as formal parameters. Actual parameters may be assigned to each of these formal parameters. In doing so, fields may be used from the input component or system component, or from the local component. Fixed values may also be entered. If a field from the output component is chosen, then this field may have to have been populated with data in an earlier processing step.

The export characteristic defines the fields that the function module will return. In a similar fashion to the import characteristics, the system may display as formal parameters the fields that may be used. Actual parameters may then be assigned to these formal parameters. For these actual parameters, the fields of the output component or local component may be used.

On a changing tab page, the system may display all the formal parameters that the function module uses as import and export characteristics. In a similar fashion to the export characteristics, the actual parameters may be entered for the formal parameters.

If the function module uses internal tables, then the actual parameters and formal parameters may be assigned on a tables tab page. On an exceptions tab page, information about the error codes of the respective function module may be viewed.

Characteristics and key figures from the environment components (input component, output component, and changing component) that have the same name may be used as actual parameters. These characteristics and key figures may then be assigned as actual parameters to the formal parameters, and this may be done in an assign environment component.

The system may copy the contents of fields to other fields. The copy fields processing step may be covered by the formal processing step. A separate copy fields step may be useful because the contents of input structure fields may have to be assigned to output structure fields. In this step, the system can assign multiple fields simultaneously.

Input and output components that have the same name as source and target fields may be chosen. The offset function may be used within a source field or target field. Depending on the application of the module editor, the processing step copy fields may be required for the transfer of input components to output components.

The tool user can be used to specify which messages can be output, and which control options are available. In the calculation module step, the system processes an existing calculation module. As in the function module processing step, the call of the calculation module may be controlled by assigning actual parameters to formal parameters. In the validity date field, the business date that is relevant for the call of the respective version of the module may be entered.

In the value determination step, the system may use characteristics to store (in generated tables) and find the following figures: currency amounts; percentages; and quantities.

The following processing steps may be defined within the do-loop: the internal table step, which may be used to edit internal tables; the table loop step, which may be used to set up a loop for processing internal tables; the database table step, which may be used by the system to access database tables; and the comment step, which may be used to enter comments.

While the present invention has been described in connection with the foregoing representative embodiment, it should be readily apparent to those of ordinary skill in the art that the representative embodiment is exemplary in nature and is not to be construed as limiting the scope of protection for the invention as set forth in the appended claims.

1. A method for building a module interactively, comprising:
defining an environment by selecting, from a field catalog, input data structures for the module;
selecting at least one processing step to be performed by the module; and
relating the at least one processing step to the input data structures.

2. The method of claim 1, further comprising selecting, from the field catalog, output data structures for the module.

3. The method of claim 1, wherein the method is performed interactively between a user and a computer program application.

4. The method of claim 1, further comprising storing the module associated with the environment.

5. The method of claim 1, further comprising defining another environment by selecting, from the field catalog, further input data structures for the other environment.

6. The method of claim 5, further comprising deactivating the environment after defining the other environment.

7. The method of claim 1, further comprising selecting from the field catalog further output data structures for the other environment.

8. The method of claim 7, further comprising:
selecting at least one further processing step to be performed by another module; and
relating the at least one further processing step to the further input data structures.

9. The method of claim 7, further comprising storing an associated date with the other module.

10. A system for building a module, comprising:
an arrangement adapted to select an environment for the module;
an arrangement adapted to define input data structures for the environment by selecting from a field catalog;
an arrangement adapted to select process steps to be performed by the module; and
an arrangement adapted to associate the input data structures with the process steps to form the module.

11. The system of claim 10, further comprising a memory adapted to store the module associated with the environment.

12. The system of claim 10, further comprising an arrangement adapted to activate an environment.

13. The system of claim 12, further comprising an arrangement adapted to create a version of the environment when further input data structures are selected from a field catalog, the further input data structures being different from the input data structures of the environment.

14. The system of claim 13, wherein the system stores the version of the environment when the version of the environment is created.

15. The system of claim 12, wherein the arrangement adapted to activate the environment is operated to activate the version of the environment.

16. The system of claim 10, wherein a user operates the system to build the module.

17. A method of editing a module, comprising:
defining a data structure by selecting from a field catalog;
storing the data structure in an environment; and
creating a version of the environment when the data structure stored in the environment is different from a previous data structure.

18. The method of claim 17, wherein the module is stored as a new version in the environment.

19. A module building tool adapted to allow a user to perform a method, the method comprising:
defining an environment from a field catalog by selecting data structures for inputs to the module and outputs from the module; and
building a module interactively by selecting processing steps to be performed and relating the processing steps to the input data structures.

20. The module building tool according to claim 19, wherein the method further comprises selecting data structures for outputs from the module.

21. A process for building a module, comprising:
creating an environment;
creating an environment version;
selecting input fields and output fields from a field catalog for the environment version;
activating the environment version;
creating a module;
creating a module version;
adding steps to a step sequence of the module version; and
activating the module version.

22. The process of claim 21, further comprising:
adding local components to the module version.
